(19) United States
(12) Patent Application Publication
(10) Pub. No.: US 2016/0332820 A1
(43) Pub. Date: Nov. 17, 2016

(54) CONVEYOR BELT AND CONVEYOR ARRANGEMENT PROVIDED WITH SUCH A BELT, AND METHOD OF PRODUCING SUCH A BELT

(71) Applicant: SANDVIK INTELLECTUAL PROPERTY AB, Sandviken (SE)

(72) Inventors: Martin LORD, Gavle (SE); Ernst NEBES, Jarbo (SE)

(21) Appl. No.: 15/110,464

(22) PCT Filed: Jan. 9, 2015
(86) PCT No.: PCT/EP2015/050347

§ 371 Date: Jul. 8, 2016

(30) Foreign Application Priority Data
Jan. 10, 2014 (EP) 14150761.6

(51) Int. Cl. B65G 15/64; B65G 39/16; B29D 29/06; B65G 15/48

(52) U.S. Cl. CPC B65G 15/64; B65G 15/48; B65G 39/16; B29D 29/06; B65G 2812/02188

(57) ABSTRACT

A conveyor belt is provided with at least one guide rim, wherein the guide rim extends in a longitudinal direction of the conveyor belt, such that it enables guiding of the belt along a lateral guide surface on an outer periphery of a roll or the like by which the direction of the belt is changed and by which the belt is subjected to a predetermined bending. The guide rim has a contact surface that is in contact with the conveyor belt. In a position in which the belt is not subjected to any bending in the longitudinal direction thereof, as seen in a cross section cross wise to the longitudinal direction of the guide rim, the guide rim presents residual stresses (σ1, σ2) including an induced tensile stress in opposite lateral regions of the contact surface and an induced compressive stress in a region between the lateral regions. The tensile stress generates a tensile force on the contact surface in a direction away from the conveyor belt and the compressive stress generates a compressive force on the contact surface towards the conveyor belt.

### TECHNICAL FIELD

The present invention relates to a conveyor belt provided with at least one guide rim, wherein the guide rim extends in a longitudinal direction of the conveyor belt such that it enables guiding of the belt along a lateral guide surface on an outer periphery of a roll or the like by means of which the direction of the belt is changed and by means of which the belt is subjected to a predetermined bending, and wherein the guide rim has a contact surface that is in contact with the conveyor belt.

The guide rim may comprise a continuous rim or a number of discrete, and thereby separated, rim sections arranged along a line on the peripheral surface of the belt. Thus, the invention is not delimited only to rims comprised by a continuous guide rim. The mentioned lateral guide surface on a roll may be defined by a groove provided in the roll, a lateral surface of a sheave (if the roll is formed by a plurality of sheaves), or a lateral end surface of the roll or any similar lateral surface provided on a roll and suitable for the mentioned purpose of guiding a guide rim of a conveyor belt.

The invention also relates to a conveyor arrangement provided with such a conveyor belt and a method of producing such a conveyor belt, by which method the contact surface of the guide rim is bonded to a peripheral surface of the belt by means of an adhesive provided between said contact surface and said peripheral surface.

### BACKGROUND OF THE INVENTION

Conveyor arrangements comprising a belt guided by a number of rolls or the like are well known and are used in a vast number of different applications in different processes, typically industrial processes. The belt material may differ depending on the specific application. However, there is often provided a guide rim thereon in order to enable the belt to be held laterally in a predetermined position with regard to the rolls or the like that it is supported by and guided by. The guide rim extends longitudinally in the longitudinal direction of the belt. It may extend continually or discontinuous along the belt. The roll, in its turn, is provided with a lateral guide surface with which the guide rim engages for the purpose of preventing the belt from being displaced laterally with regard to the roll or rolls.

Typically, the guide rim is made of a softer material than the belt itself and attached to the latter by means of an adhesive such as a glue or the like that is applied to the surface of the belt and/or to a contact surface of the guide rim prior to the positioning of the latter on the belt. In many applications, the belt is made of metal, preferably steel, and the guide rim is made of rubber. The adhesive may be any suitable adhesive, such as glue or the like, that enables a chemical bonding of the rubber to the metal.

Due to several reasons, such as the chemical environment that the belt is subjected to when used in a specific process, and the physical strains that the guide rim is subjected to, the latter may have a tendency to lose its bonding to the belt, thereby not contributing to its intended lateral positioning and guiding of the belt with regard to the roll or rolls around which the belt extends. Prior art seeks to solve this problem by presenting adhesives and rim materials that will ensure a sufficient bonding of the guide rim to the belt over time, and with regard taken to the specific conditions of different applications.

### THE OBJECT OF THE INVENTION

It is an object of the present invention to present a conveyor belt provided with a guide rim, the design of which will promote an improved adhesion of the guide rim to the belt.

It is also an object of the invention to present a method of producing a conveyor belt according to the invention.

### SUMMARY OF THE INVENTION

The object of the invention is achieved by means of the initially defined conveyor belt, characterised in that, in a position in which the belt is not subjected to any bending in the longitudinal direction thereof, as seen in a cross section cross wise, i.e. perpendicular, to the longitudinal direction of the guide rim, the guide rim presents residual stresses comprised by an induced tensile stress in opposite lateral regions of said contact surface and an induced compressive stress in a region between said lateral regions, said tensile stress generating a tensile force on the contact surface in a direction away from the conveyor belt and said compressive stress generating a compressive force on the contact surface towards the conveyor belt.

Upon bending of the conveyor belt around a roll or the like, with which the guide rim engages, the guide rim will be subjected to a corresponding bending. If the guide rim does not present the induced tensile stress and compressive stress respectively, as suggested by the present invention, a compressive stress will be induced in the opposite lateral regions of said cross section of the contact surface, and a tensile stress will be induced in region between these lateral regions. The combination of such stresses and the further strain, such as lateral forces on the guide rim caused by the interaction with the lateral guide surface of a roll, that the guide rim will be subjected to during the bending thereof, will be detrimental to the bonding between the rim and the belt surface and may finally cause the breaking of such bonding. By inducing the aforementioned residual stresses in the guide rim, and preferably adapting the level thereof to an assumed predetermined bending of the belt, which depends on the conceived application, a stress condition that is favourable to the endurance of the adhesion between the belt and the guide rim can be achieved. If the level of the residual stresses is properly adapted, the maximum tensile forces that appear at the joint between the contact surface of the guide rim and the peripheral surface of the belt during use of the conveyor belt with repeated bending of segments thereof that passes over rolls, can be reduced and the endurance of the joint be improved as a result thereof.

According to a preferred embodiment, the level of the induced tensile stresses and the induced compressive stress respectively are adapted to the dimension of said predetermined bending of the belt, such that the maximum tensile stress generated at the contact surface upon said predetermined bending is less than the maximum tensile stress induced at said surface when the belt is not subjected to bending in the longitudinal direction thereof.

According to a preferred embodiment the level of the induced tensile stresses and the induced compressive stress respectively are adapted to the dimension of said predetermined bending of the belt, such that upon the conceived bending of the belt the absolute value of the residual stresses in the region of said contact surface is reduced compared to when the belt is not subjected to bending in the longitudinal direction thereof.

According to yet another embodiment, the absolute value of the residual stresses in said region are reduced to less than half of its value, when subjected to said predetermined bending, compared to when the belt is not subjected to bending in the longitudinal direction thereof.

According to yet another embodiment, the level of said induced tensile stress is adapted to a predetermined bending of the belt such that it becomes generally zero when the belt is subjected to said predetermined bending.

According to one embodiment, the conveyor belt is a metal belt and the guide rim comprises rubber as its main constituent. Preferably, the belt is a steel belt. Preferably, the rubber is a rubber from the group consisting of nitrile rubber, chloroprene rubber, natural rubber or silicone rubber.

Preferably, the guide rim is attached to the belt through an adhesive provided between the contact surface of the guide rim and a surface of the belt. The adhesive may be a one-coat adhesive for bonding polar elastomers to metals and other rigid substrates during vulcanization, said adhesive consisting of reactive polymers and pigments in methyl isobutyl ketone (MIBK) and methyl ethyl ketone (MEK). One such adhesive is marketed by Rohm and Haas under the name MEGUM™ 3340-1. Other possible adhesives are any of the adhesives commercialized by Rohm and Haas under the trade names MEGUM and THIXON, and marketed as being suitable for bonding elastomers and rubbers to metal.

According to one embodiment, said predetermined bending has a bend radius r in the range of 250×t-3000×t, wherein t is the thickness of the belt. Preferably, r>500×t. Preferably, r<1500×t.

Preferably, the thickness t of the belt is in the range of 0.1 mm-4 mm. Preferably, t>0.3 mm. Preferably, t<2 mm.

The object of the invention is also achieved by a conveyor arrangement, characterised in that it comprises a conveyor belt according to the invention and at least one roll by which the conveyor belt is supported and by means of which the belt is redirected and subjected to said predetermined bending, said roll comprising at least one lateral guide surface provided on an outer periphery thereof for the purpose of laterally supporting said guide rim, thereby enabling the guide rim to guide the belt along a predetermined path and at a predetermined position on the roll. Preferably, the conveyor arrangement comprises at least two rolls that support and direct the belt. At least one of said rolls is driven by a drive unit, for the purpose of driving the belt. Each incremental part of the belt will be subjected to a repeated bending as it travels thorough the path along which the belt runs.

The object of the invention is also achieved by means of a method of producing a conveyor belt according to the invention, wherein the contact surface of the guide rim is bonded to a peripheral surface of the belt by means of an adhesive provided between said contact surface and said peripheral surface, characterised in that said peripheral surface of the belt is generally flat and that the guide rim is provided with a convex base surface, as seen in a cross section cross wise to the longitudinal direction thereof, and in that said base surface is pressed towards said peripheral surface and deformed to a generally flat state, thereby defining said contact surface of the guide rim. The suggested method is a preferred way of providing the desired residual stresses in the guide rim.

Preferably, the convexity of the base surface is adapted such that said residual stresses are induced in the guide rim upon said pressing of the base surface towards said peripheral surface into said generally flat state in which it defines said contact surface. In other words, a convexity is chosen such that residual stresses will be induced in the rim that will result in the desired stress relief during a conceived predetermined bending of the belt, as defined for the conveyor belt according to the invention.

Preferably, the convexity of the base surface, defined as the relation between height h and width w of the base surface, is in the range of w/10000<h<w/100. Preferably, h>w/5000. The chosen width of the guide rim, depends on the thickness and width of the belt. The base surface may, but need not necessarily, define the widest part of the guide rim. The rim may have any shape that makes it suitable for the purpose of guiding the belt on a roll provided with a corresponding lateral guide surface for engagement with the guide rim. If the guide rim is too wide or bulky with regard the thickness of the belt, it may cause an unwanted sagging of the belt where the latter runs unsupported. If the guide rim is not sufficiently wide and/or too high, it might be prone to plying. Therefore, typically, the rim has a height in the range of 1-4 cm, and a width in the range of 0.5-4 cm, preferably in the range of 1-3 cm.

Preferably, said adhesive is applied to any of said base surface and said peripheral surface prior to the pressing of said base surface of the guide rim towards said peripheral surface, and, after said pressing, the adhesive is subjected to conditions, typically a heating operation, that causes the adhesive to bond the contact surface of the guide rim to the peripheral surface of the belt.

Further features and advantages of the present invention will be presented in the following detailed description of embodiments of the invention.

### BRIEF DESCRIPTION OF THE DRAWINGS

Hereinafter, by way of example, the invention will be described more in detail with reference to the annexed drawing, on which:

FIG. 1 is a side view of a conveyor arrangement according to the invention,

FIG. 2 is a view from above of a part of the conveyer arrangement shown in FIG. 1

FIG. 3 is a cross section of a part of a conveyor belt according to the invention,

FIG. 4 is a cross section of a guide rim provided on the conveyor belt in a non-bent position, with tensile and compressive stresses in the region of the contact surface of the guide rim indicated,

FIG. 5 is side view of a part of a conveyer belt according to the invention, subjected to a predetermined bending,

FIG. 6 is a cross section of a guide rim provided on the bent conveyor belt according to FIG. 5, with tensile and compressive stresses indicated,

FIGS. 7a-7c are cross sections showing steps of a method of producing a conveyor belt provided with a guide rim according to the invention,

FIG. 8 is a cross section of a conveyor belt provided with a guide rim according to prior art, when the belt is in a non-bent state, with stresses therein indicated, and

FIG. 9 is a cross section of a conveyor belt provided with a guide rim according to prior art, when the belt is in a bent state, and with stresses therein indicated.

### DETAILED DESCRIPTION OF THE INVENTION

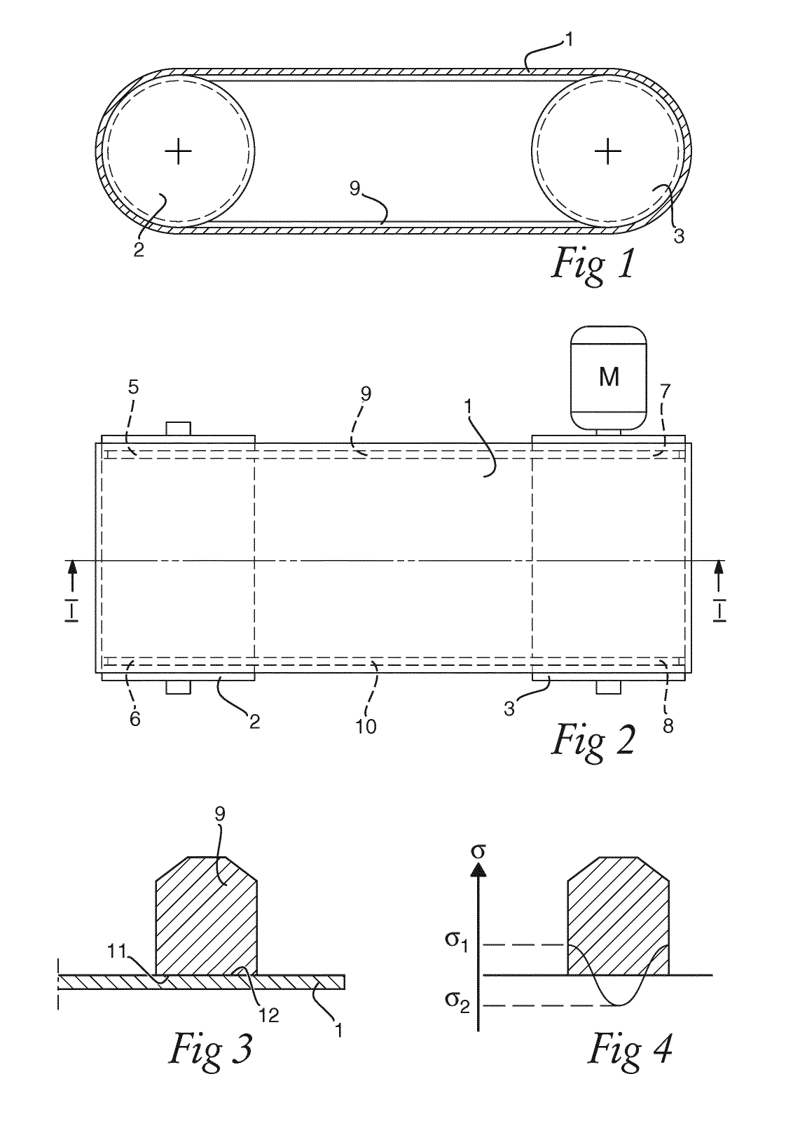

FIG. 1 shows a conveyor arrangement according to one embodiment of the invention. The conveyor arrangement comprises a conveyor belt 1 and rolls 2, 3 against which the conveyor belt 1 is supported and around which it defines a path. Preferably, the conveyor belt is a metal belt, preferably a steel belt. As seen in FIG. 2, the arrangement also preferably comprises a drive unit, indicated with M and connected to one of the rolls 2, 3 for the purpose of generating a rotating motion of the latter, which will, in its turn generate a motion of the conveyor belt 1 along the path thereof. The drive unit M may be of any kind suitable for its purposes, such as an electric engine or the like. Here, the rolls 2, 3 comprise drums. However, it should be understood that each roll 2, 3 could as well comprise a set of parallel sheaves.

The rolls 2, 3 are provided with lateral guide surfaces defined by grooves 5, 6, 7, 8, indicated in FIG. 2, which run circumferentially on an outer periphery of the respective roll 2, 3 and which are aimed for the purpose of receiving a respective guide rim 9, 10 that is provided on an outer surface of the conveyor belt 1. If the rolls are instead formed by sheaves, the lateral guide surfaces will be formed by the lateral surfaces of the sheaves. It is also conceivable that the lateral support surface is formed by a lateral end surface of the roll, irrespectively of the roll being formed like a drum or a set of sheaves. Accordingly, it is obviated that grooves is only one of several possible ways of embodying the lateral guide surfaces provided on the rolls. What is hereinafter mentioned with regard to the interaction between grooves and guide rim could thus be regarded as valid also for corresponding interaction between other embodiments of lateral guide surfaces and the guide rim. There may be one or more guide rims provided on the conveyor belt 1. Thus, even though this embodiment is described as comprised by two such rims, it should be understood that the number thereof may be different. The guide rims 9, 10 project from the surface of the conveyor belt 1 and engage the respective groove 5, 6, 7, 8. By the interaction of the grooves 5, 6, 7, 8 and the guide rims 9, 10 the conveyor belt 1 is guided along its path and prevented from being displaced in a lateral direction on the respective roll.

FIG. 3 shows a cross section of a one embodiment of a guide rim 9, as seen in a cross wise to the longitudinal direction of the guide rim. The guide rim 9 presents a contact surface 11 which bears against a peripheral surface 12 of the conveyor belt 1. The contact surface 11 of the guide rim 9 is attached to the peripheral surface of the belt 1 by means of an adhesive (not visible in the figure). Preferably, the guide rim 9 is comprised by a rubber, such as a nitrile rubber, a natural rubber, a chloroprene rubber or the like.

As a direct consequence of the design of the arrangement, each incremental part of the belt 1 will be subjected to a repeated bending as it travels through the path along which the belt 1 runs. Each incremental part of the guide rims 9, 10 will be subjected to a corresponding bending, and this bending will take place when that incremental part is in engagement with the grooves 5-8 of the rolls 2, 3. As an incremental part of the guide rim 9 is subjected to said bending, it is deformed and as a result thereof a different stress state will appear in said incremental part compared to when it is not subjected to said bending. It has been noted that, upon such bending, in the region of the contact surface of the guide rim 9, 10, the lateral parts of the cross section thereof will be subjected to an increased compressive stress while the middle part between these lateral parts is subjected to an increased tensile stress. If no countermeasure is taken, the increased tensile stress will result in a tensile force that affects the middle part of the guide rim 9, 10 in a direction away from the peripheral surface of the belt 1, while the lateral parts of the contact surface are pressed towards the belt due to the increased tensile stress in those parts. The upcoming of such a stress state is inconvenient with regard to the fact that the guide rim is also likely to be subjected to further forces, such as lateral forces, as it engages any of the grooves 5-8. In order to avoid such stresses in the guide rim, the present invention teaches that the guide rim should have residual stresses in the non-bent state, and that these residual stresses should be such that they counteract and suppress the upcoming of the afore-mentioned stress state during the predetermined bending of the guide rim 9, 10.

FIG. 4 shows a cross section of an embodiment of the guide rim 9 in a non-bent state in which the requested residual stresses are indicated. σ₁ indicates tensile stresses that are induce in opposite lateral regions of the contact surface 11 of the guide rim and σ₂ indicates an induced compressive stress in a region between said lateral regions. The said tensile stresses σ₁ generate a tensile force on the contact surface in a direction away from the conveyor belt and said compressive stress σ₂ generates a compressive force on the contact surface towards the conveyor belt. The level of the induced tensile stresses σ₁ and the compressive stress σ₂ should be adapted to a conceived predetermined bending that the belt is assumed to be subjected to during use thereof, i.e. during passage of rolls that direct the belt.

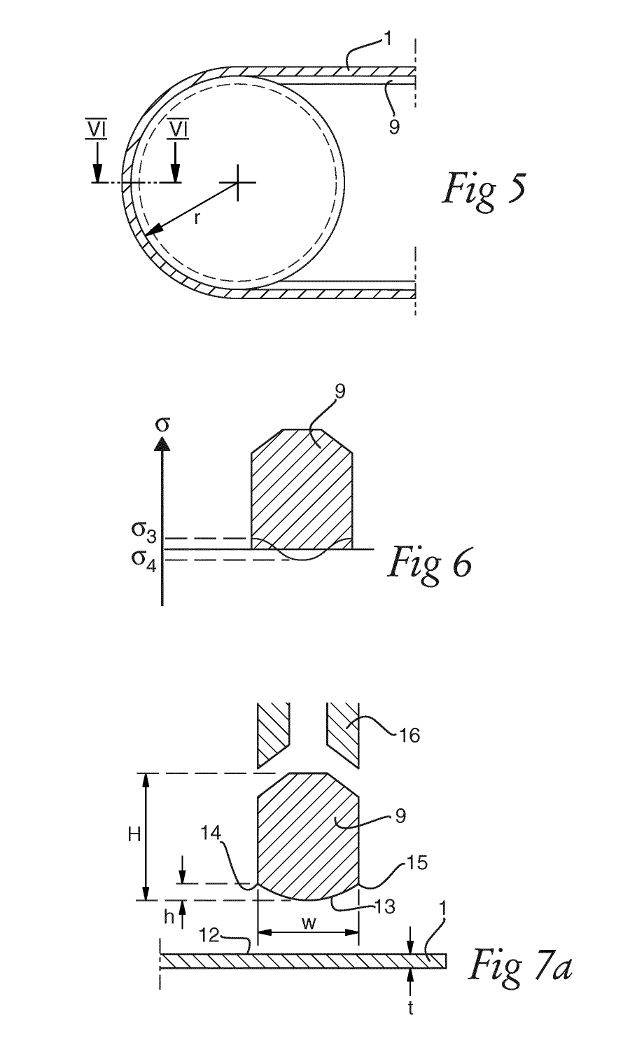

FIG. 5 shows a part of the belt 1 that is subjected to bending as it passes a roll 2 of the conveyor arrangement. The bend radius, which in this particular case also happens to be generally the radius of the roll 2, is indicated with r. The guide rim 9, 10, in its non-bent state, is provided with the afore-mentioned residual stresses σ₁, σ₂ that will counteract the upcoming of an undesired stress state in the bent state of the guide rim 9, 10.

FIG. 6 shows the stress state that appears in the contact surface 11 of an incremental part of the guide rim 9, 10 during the bending thereof shown in FIG. 5. The remaining stresses, indicated with σ₃ and σ₄, are at a very low level. Ideally, the residual stresses σ₁, σ₂ should be eliminated as a result of the counteracting stresses that are induced in the guide rim as a result of the bending thereof, but it might be difficult to arrive at such a result, and therefore it might be preferred to adapt the residual stresses σ₁, σ₂ to the predetermined bending such that there is no shift from tensile stress to compressive stress in the lateral regions and middle region of the contact surface respectively. Thereby, as shown in FIG. 6, a small remaining tensile stress σ₃ is accepted in the lateral regions of the contact surface 11 of the guide rim 9, 10 and a small remaining compressive stress σ₄ is accepted in the middle region between said lateral regions. In any case, the level of the remaining stresses σ₃ and σ₄ (in absolute terms) should be considerably lower than the level would have been if no residual stresses would have been provided, preferably less than half the absolute value otherwise obtained.

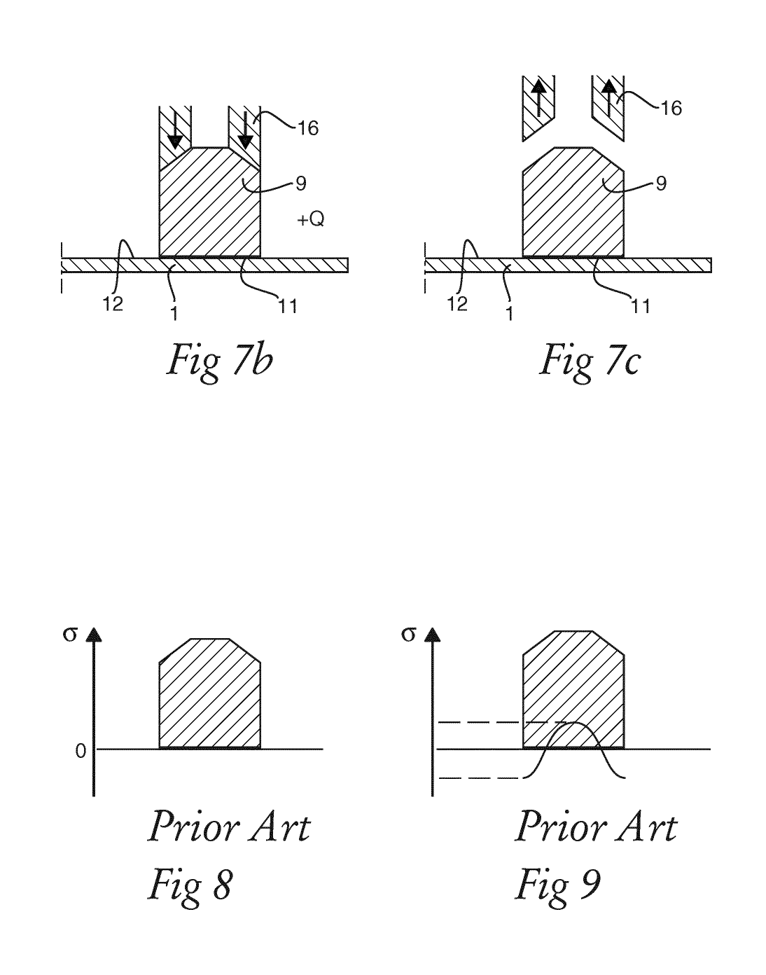

FIGS. 7a, 7b and 7c show essential steps of a method of inducing the afore-mentioned residual stresses in a guide rim 9 that is attached to a peripheral surface of a conveyer belt 1 according to the invention. As seen in a cross section perpendicular to the longitudinal direction of the guide rim 9, the latter is provided with a convex base surface 13. The base surface 13 has a width w and, from a line 13 that extends between two opposite lateral ends 14, 15 of the base surface 13, the base surface 13 presents a height h. The convexity of the base surface can be defined by the relation between w and h. Preferably, w/10000<h<w/100. Normally, for cases in which the thickness of the belt is in the range of 0.1-4 mm, preferably 0.3-2 mm, the width w of the base surface 13 of the guide rim 9, 10 is equal to or above 5 mm, preferably equal to or above 10 mm, and most preferably equal to or above 12.5 mm in order to ensure sufficient lateral stability of the guide rim 9, 10, and, preferably, the width w of the base surface 13 of the guide rim 9, 10 is equal to or below 100 mm, preferably equal to or below 50 mm, and most preferably equal to or below 30 mm in order not to negatively affect the belt. H is the height of the guide rim 9, 10. Preferably H≧w/10, and more preferably H≧w/2 in order to ensure sufficient engagement with the lateral guide surface of a roll, such as the grooves of any of the rolls 2, 3. Preferably, H≦w×3, and more preferably H≦w×2 in order to ensure sufficient lateral stability of the guide rim 9, 10.

The chosen convexity depends on the predetermined bend radius r that each incremental part of the guide rim 9 can be expected to be repeatedly subjected to while traveling along the path that the conveyor belt 1 defines in a specific conveyor arrangement, such as the one exemplified in FIGS. 1 and 2. Also the material, size and geometric shape of the rubber rim 9, 10 will be decisive for which convexity that is chosen as a means for obtaining the requested residual stresses therein, once the guide rim has been attached to the belt 1. However, for most applications that can be conceived for the time being, the radius r will be in the range of t×250-t×3000, where t is the thickness of the belt 1. Preferably the radius r, will be in the range of t×350-t×500.

As can be seen in FIG. 7a a press tool 16 is used for pressing the base surface 13 of the guide rim 9, 10 against the peripheral surface 12 of the belt 1. Previously to such pressing, any of said peripheral surface 12 or the base surface 13 has been provided with an adhesive. The adhesive may be any kind of suitable resin, preferably a heat-curable resin.

Preferably, the upper part of the guide rim 9, 10, against which the press tool 16 is applied, has a cross section with the shape of a truncated cone. The press tool 16 is applied against the opposite bevelled surfaces of said truncated cone with corresponding bevelled surfaces of its own. Thereby the lateral regions of the base surface 13 can be pressed towards the belt 1 without excessive force being applied to the central part of the guide rim 9, 10. Preferably, the part of the belt 1 onto which the guide rim 9, 10 is applied by means of the press tool 16 is in a generally non-bent state during said application.

As can be seen in FIG. 7b, the press tool 16 presses the guide rim 9, 10 towards the peripheral surface 17 of the belt 1 such that the base surface 13 of the guide rim 9, 10 is flattened out and defines the contact surface 11 previously mentioned. Heat, indicated with Q in FIG. 7b is provided in order to cause a chemical reaction of the adhesive, such as the curing thereof. This can be achieved by letting the belt pass a heat source directed towards the region of the guide rim 9, 10, or by any other suitable method, which will be obvious the person skilled in the art. As an alternative, the adhesive is of a kind that will react chemically and form said bonding without any particular heating, or heating is provided before the guide rim 9, 10 is pressed towards the belt, such that said chemical reaction takes place immediately when the guide rim 9, 10 is pressed against the belt 1.

After adhesion has been completed, the pressure applied by means of the press tool 16 is relieved, and the press tool 16 is retreated from the guide rim 9, 10, as indicated in FIG. 7c. Thanks to the provision of the convexity of the base surface 13 of the guide rim 9, 10, the guide rim is now provided with the previously described residual stresses σ₁ and σ₂.

FIG. 8 shows the cross section of a conveyor belt provided with a guide rim according to prior art, wherein the incremental part of the belt that is shown is not subjected to any bending. In other words, the cross section corresponds to the one presented in FIG. 4. The cross section of FIG. 8 shows that there are essentially no residual stresses induced in guide rim.

FIG. 9 illustrates the same cross section as FIG. 8, but with the difference that the shown incremental part of the belt is now subjected to a bending corresponding to the bending that the belt would be subjected to upon passage of the outer periphery of a directing roll or the like, with a groove of which the guide rim of the belt is assumed be in engagement. As can be seen, stresses are induced into the guide rim in the region of its contact surface as a consequence of the specific bending thereof. In particular, it should be noted that compressive stresses will be induced in the opposite lateral regions of the guide rim while a tensile stress is induced in the region between these regions. This stress state should be compared to the stress state that a corresponding incremental part of a guide rim of the present invention would present when subjected to the corresponding bending, as shown in FIG. 6. The provision of the induced residual stresses according to the invention obviously results in less stresses in the bent state of the guide rim.

1. A conveyor belt comprising at least one guide rim, wherein the guide rim extends in a longitudinal direction of the conveyor belt such that it enables guiding of the belt along a lateral guide surface provided on an outer periphery of a roll or the like by which the direction of the belt is changed and by which the belt is subjected to a predetermined bending, the guide rim including a contact surface that is in contact with the conveyor belt, wherein, in a position in which the belt is not subjected to any bending in the longitudinal direction thereof, as seen in a cross section, cross wise to the longitudinal direction of the guide rim, the guide rim presenting residual stresses including an induced tensile stress in opposite lateral regions of said contact surface and an induced compressive stress in a region between said lateral regions, said tensile stress generating a tensile force on the contact surface in a direction away from the conveyor belt and said compressive stress generating a compressive force on the contact surface towards the conveyor belt.

2. A conveyor belt according to claim 1, wherein the level of the induced tensile stresses (σ1) and the induced compressive stress (σ2) respectively are adapted to the dimension of said predetermined bending of the belt, such that the maximum tensile stress generated at the contact surface upon said predetermined bending is less than the maximum tensile stress induced at said surface when the belt is not subjected to bending in the longitudinal direction thereof.

3. A conveyor belt according to claim 1, wherein the level of the induced tensile stresses and the induced compressive stress respectively are adapted to the dimension of said predetermined bending of the belt, such that upon the conceived bending of the belt an absolute value of the residual stresses in the region of said contact surface is reduced compared to when the belt is not subjected to bending in the longitudinal direction thereof.

4. A conveyor belt according to claim 3, wherein the absolute value of the residual stresses in said region are reduced to less than half of its value compared to when the belt (1) is not subjected to bending in the longitudinal direction thereof.

5. A conveyor belt according to claim 2, wherein the level of said induced tensile stress is adapted to a predetermined bending of the belt such that it becomes generally zero when the belt is subjected to said predetermined bending.

6. A conveyor belt according to claim 1, wherein the conveyor belt is a metal belt and the guide rim has rubber as its main constituent.

7. A conveyor belt according to claim 1, wherein the guide rim is attached to the belt through an adhesive provided between the contact surface of the guide rim and a surface of the belt.

8. A conveyor belt according to claim 1, wherein said predetermined bending has a bend radius in the range of 250 t-3000 t, wherein t is the thickness of the belt.

9. A conveyor belt according to claim 8, wherein the thickness t of the belt is in the range of 0.1 mm-4 mm.

10. A conveyor arrangement comprising:
a conveyor belt including at least one guide rim, wherein the guide rim extends in a longitudinal direction of the conveyor belt such that it enables guiding of the belt along a lateral guide surface provided on an outer periphery of a roll or the like by which the direction of the belt is changed and by which the belt is subjected to a predetermined bending, the guide rim including a contact surface that is in contact with the conveyor belt, wherein, in a position in which the belt is not subjected to any bending in the longitudinal direction thereof, as seen in a cross section, cross wise to the longitudinal direction of the guide rim, the guide rim presenting residual stresses including an induced tensile stress in opposite lateral regions of said contact surface and an induced compressive stress in a region between said lateral regions, said tensile stress generating a tensile force on the contact surface in a direction away from the conveyor belt and said compressive stress generating a compressive force on the contact surface towards the conveyor belt; and
at least one roll supporting the conveyor belt and by which the belt is redirected and subjected to said predetermined bending, said roll having at least one lateral guide surface provided on an outer periphery thereof for the purpose of laterally supporting said guide rim, thereby enabling the guide rim to guide the belt along a predetermined path and at a predetermined position on the roll.

11. A method of producing a conveyor belt comprising:
providing a at least one guide rim, wherein the guide rim extends in a longitudinal direction of the conveyor belt such that it enables guiding of the belt along a lateral guide surface provided on an outer periphery of a roll or the like by which the direction of the belt is changed and by which the belt is subjected to a predetermined bending, the guide rim including a contact surface that is in contact with the conveyor belt, wherein, in a position in which the belt is not subjected to any bending in the longitudinal direction thereof, as seen in a cross section, cross wise to the longitudinal direction of the guide rim, the guide rim presenting residual stresses including an induced tensile stress in opposite lateral regions of said contact surface and an induced compressive stress in a region between said lateral regions, said tensile stress generating a tensile force on the contact surface in a direction away from the conveyor belt and said compressive stress generating a compressive force on the contact surface towards the conveyor belt;
bonding the contact surface of the guide rim to a peripheral surface of the belt by an adhesive provided between said contact surface and said peripheral surface, wherein the peripheral surface of the belt is generally flat and that the guide rim is provided with a convex base surface, as seen in a cross section cross wise to the longitudinal direction thereof; and
pressing said base surface towards said peripheral surface and deforming the base surface to a generally flat state, thereby defining said contact surface of the guide rim.

12. A method according to claim 11, wherein the convexity of the base surface is arranged such that said residual stresses are induced in the guide rim upon said pressing of the base surface towards said peripheral surface into said generally flat state in which it defines said contact surface.

13. A method according to claim 11, wherein the convexity of the base surface, defined as the relation between height h and width w of the base surface, is in the range of w/10000<h<w/100.

14. A method according to claim 11, wherein said adhesive is applied to any of said base surface and said peripheral surface prior to the pressing of said base surface of the guide rim towards said peripheral surface, and that, after said pressing, the adhesive is subjected to a heating operation that causes the adhesive to bond the contact surface of the guide rim to the peripheral surface of the belt.
